(19) United States
(12) Patent Application Publication
(10) Pub. No.: US 2020/0176203 A1
(43) Pub. Date: Jun. 4, 2020

(54) MULTIFUNCTION SWITCH

(71) Applicant: MIYAMA ELECTRIC CO., LTD., Tokyo (JP)

(72) Inventor: Tomochika SHIBUYA, Tokyo (JP)

(21) Appl. No.: 16/681,811

(22) Filed: Nov. 12, 2019

(30) Foreign Application Priority Data
Nov. 29, 2018 (JP) 2018-223421

(51) Int. Cl. H01H 25/04; H01H 23/16

(52) U.S. Cl. CPC H01H 25/041; H01H 2025/043; H01H 23/16

(57) ABSTRACT

Provided is a multifunction switch (1) having a switching function for an electrical contact switch and a switching function for a mechanical element. The multifunction switch (1) includes a swingable control body (20) having a control pin (22), a movable contact (31) coming into contact with the control pin (22), and a movable element (40) having the control pin (22) running therethrough and swingably supported. With the control pin (22) being swung, the movable contact (31) is pressed by the control pin (22) to come into contact with a fixed contact (32) and the movable element (40) is swung by the control pin (22) to implement mechanical switching for an additional element.

### CROSS-REFERENCE TO RELATED APPLICATION

This application claims the benefit of priority to Japanese Patent Application No. 2018-223421 filed on 29 Nov. 2018, the disclosures of all of which are hereby incorporated by reference in their entireties.

### TECHNICAL FIELD

The present invention relates to a multifunction switch.

### BACKGROUND ART

A switch of a related art includes a swingable pusher, a swinging contact plate to be swung by the pusher, and a fixed contact to contact the swinging contact plate in a swung state (see Japanese Patent Application Publication No. H10-247441).

### SUMMARY OF THE INVENTION

### Problems to be Solved

The above-described switch only serves as an electrical contact switch and does not have a switching function for an additional mechanical element. Accordingly, when a switching function for the mechanical element is added to the switch, the switch requires other parts to end up having more parts and more complicated structure, and accordingly increased costs.

The present invention is intended to provide a multifunction switch having a switching function for an electrical contact switch and a switching function for a mechanical element.

### Solution to Problems

A multifunction switch is provided to achieve the above-identified objective and includes a swingable control body having a control pin, a movable contact coming into contact with the control pin, and a movable element having the control pin running therethrough and swingably supported. With the control pin being swung, the movable contact is pressed by the control pin to come into contact with a fixed contact and the movable element is swung by the control pin to implement mechanical switching for a target element.

### Advantageous Effects of the invention

With use of the present invention, the movable contact and the fixed contact implement switching for an electrical contact switch and the movable element is swung to implement switching for the target element, for example. The movable element is incorporated into the swinging switch to have a simple and inexpensive configuration with a small number of parts.

### BRIEF DESCRIPTION OF DRAWINGS

FIG. 1 is a perspective view of a multifunction switch of a first embodiment;

FIG. 2A is a plan view of the multifunction switch shown in FIG. 1;

FIG. 2B is a side view of the multifunction switch shown in FIG. 1;

FIG. 3A is a partially-exploded plan view of the multifunction switch in FIG. 1;

FIG. 3B is a partially-exploded perspective view of the multifunction switch in FIG. 1,

FIG. 3C is a partially-exploded perspective view of the multifunction switch in FIG. 1,

FIG. 4 is an exploded perspective view of the multifunction switch in FIG. 1;

FIG. 5A is an enlarged perspective view of a first movable element in FIG. 4;

FIG. 5B is an enlarged perspective view of a second movable element in FIG. 4;

FIG. 5C is an enlarged perspective view of a slider in FIG. 4;

FIG. 5D is an enlarged perspective view of a movable contact in FIG. 4;

FIG. 5E is an enlarged perspective view of a basal plate in FIG. 4;

FIG. 6A is a cross-sectional view taken along a line VIA-VIA in FIG. 2;

FIG. 6B is a cross-sectional view taken along a line VIB-VIB in FIG. 2;

FIG. 7A is a cross-sectional view taken along a line VIIA-VIIA in FIG. 2;

FIG. 7B is a cross-sectional view taken along a line VIIB-VIIB in FIG. 2;

FIG. 8A is a plan view of the multifunction switch having a control cap swung toward a direction indicated by A1;

FIG. 8B is a side view of the multifunction switch in FIG. 8A;

FIG. 8C is a cross-sectional view, taken along a line VIIIC-VIIIC, of the multifunction switch in FIG. 8A;

FIG. 8D is a cross-sectional view, taken along a line VIIID-VIIID, of the multifunction switch in FIG. 8A;

FIG. 9A is a plan view of the multifunction switch having the control cap swung toward a direction indicated by B1;

FIG. 9B is a side view of the multifunction switch in FIG. 9A;

FIG. 9C is a cross-sectional view, taken along a line IXC-IXC, of the multifunction switch in FIG. 9A;

FIG. 9D is a cross-sectional view, taken along a line IXD-IXD, of the multifunction switch in FIG. 9A;

FIG. 10A is a plan view of the multifunction switch having the control cap swung toward a direction indicated by C1;

FIG. 10B is a side view of the multifunction switch in FIG. 10A;

FIG. 10C is a cross-sectional view, taken along a line XC-XC, of the multifunction switch in FIG. 10A;

FIG. 10D is a cross-sectional view, taken along a line XD-XD, of the multifunction switch in FIG. 10A;

FIG. 11A is a plan view of the multifunction switch having the control cap swung toward a direction indicated by D1;

FIG. 11B is a side view of the multifunction switch in FIG. 11A;

FIG. 11C is a cross-sectional view, taken along a line XIC-XIC, of the multifunction switch in FIG. 11A;

FIG. 11D is a cross-sectional view, taken along a line XID-XID, of the multifunction switch in FIG. 11A;

FIG. 12 is a perspective view of a multifunction switch of a second embodiment;

FIG. 13A is a plan view of the multifunction switch in FIG. 12;

FIG. 13B is a side view of the multifunction switch in FIG. 12;

FIG. 14A is a partially-exploded perspective view of the multifunction switch in FIG. 12;

FIG. 14B is a partially-exploded plan view of the multifunction switch in FIG. 12;

FIG. 14C is a partially-exploded perspective view of the multifunction switch in FIG. 12;

FIG. 14D is a perspective view of a basal plate of the multifunction switch in FIG. 12;

FIG. 15 is an exploded perspective view of the multifunction switch in FIG. 12;

FIG. 16A is an enlarged perspective view of a first movable element in FIG. 15;

FIG. 16B is an enlarged perspective view of a second movable element in FIG. 15;

FIG. 16C is an enlarged perspective view of a driven slider in FIG. 15;

FIG. 17A is a cross-sectional view taken along a line XVIIA-XVIIA in FIG. 13A;

FIG. 17B is a cross-sectional view taken along a line XVIIB-XVIIB in FIG. 13B;

FIG. 17C is a cross-sectional view taken along a line XVIIC-XVIIC in FIG. 13B;

FIG. 18A is a plan view of the multi-function switch having the control cap swung toward the direction indicated by B1;

FIG. 18B is a side view of the multifunction switch having the control cap swung toward the direction indicated by B1;

FIG. 18C is a cross-sectional view taken along a line XVIIIC-XVIIIC in FIG. 18A;

FIG. 19A is a plan view of the multifunction switch having the control cap swung toward the direction indicated by C1;

FIG. 19B is a side view of the multifunction switch having the control cap swung toward the direction indicated by C1;

FIG. 19C is a cross-sectional view taken along a line XIXC-XIXC in FIG. 19A;

FIG. 19D is a cross-sectional view taken along a line XIXD-XIXD in FIG. 19A;

FIG. 20A is a plan view of a multifunction switch of a third embodiment;

FIG. 20B is a side view of the multifunction switch in FIG. 20A;

FIG. 20C is an exploded perspective view of the multifunction switch in FIG. 20A;

FIG. 20D is a bottom view of the control cap in FIG. 20C;

FIG. 20E is a top view of a case in FIG. 20C;

FIG. 21A is a cross-sectional view taken along a line XXIA-XXIA in FIG. 20A;

FIG. 21B is a cross-sectional view taken along a line XXIB-XXIB in FIG. 20A;

FIG. 22A is a cross-sectional view taken along a line XXIIA-XXIIA in FIG. 20B;

FIG. 22B is a cross-sectional view taken along a line XXIIB-XXIIB in FIG. 20B;

FIG. 23A is a plan view of the multi-function switch having the control cap swung toward the direction indicated by A1;

FIG. 23B is a cross-sectional view, taken along a line XXIIIB-XXIIIB in FIG. 23A, of the multifunction switch having the control cap swung toward the direction indicated by A1;

FIG. 23C is a cross-sectional view taken along a line XXIIIC-XXIIIC in FIG. 23A;

FIG. 23D is a cross-sectional view taken along a line XXIIID-XXIIID in FIG. 23B;

FIG. 24A is a plan view of the multifunction switch having the control cap swung toward the direction indicated by D1;

FIG. 24B is a cross-sectional view, taken along a line XXIVB-XXIVB in FIG. 24A, of the multifunction switch having the control cap swung toward the direction indicated by D1; and

FIG. 24C is a cross-sectional view taken along a line XXIVC-XXIVC in FIG. 24B.

### DETAILED DESCRIPTION OF EMBODIMENTS

### First Embodiment

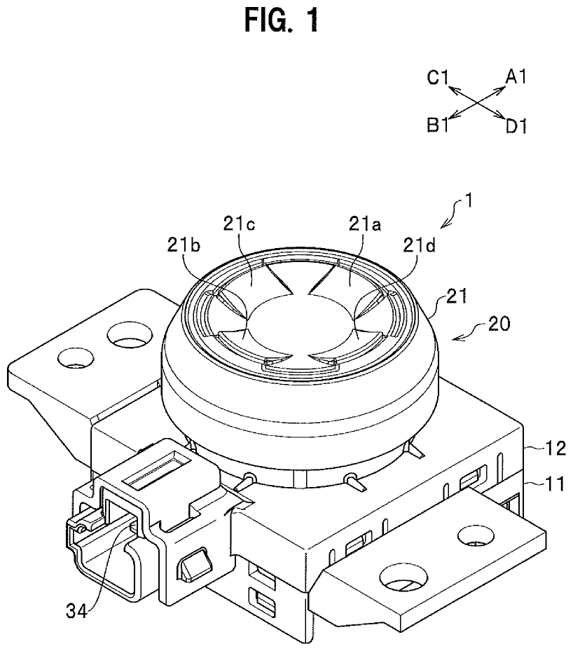

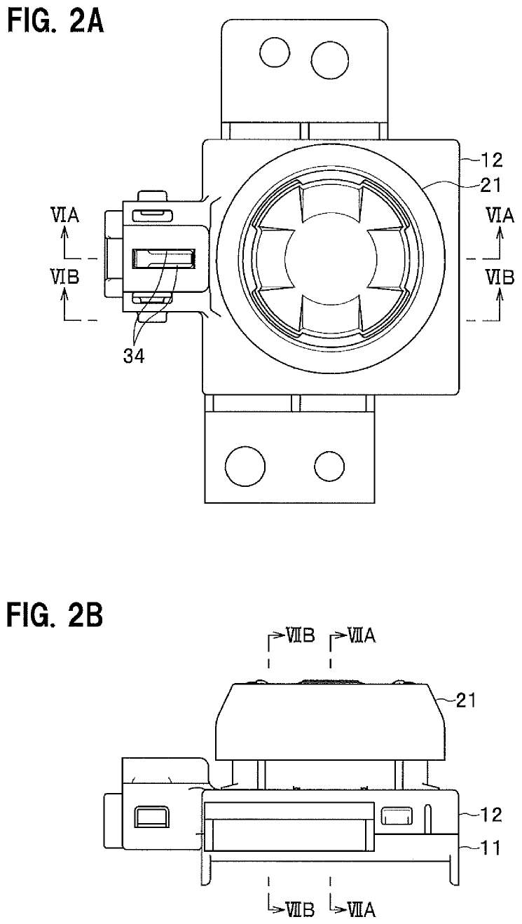

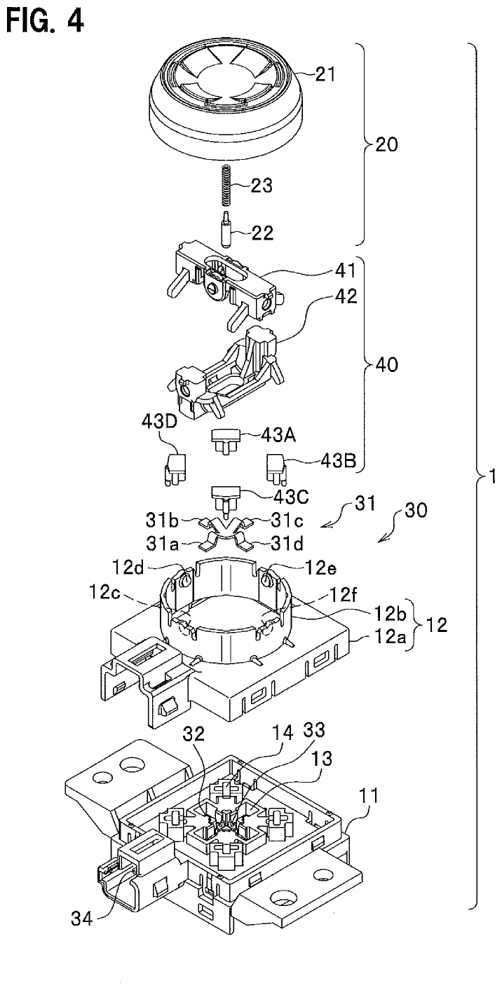

Hereinafter, embodiments of the present invention will be described with reference to the drawings. A multifunction switch 1 includes a swingable control body 20, a contact circuit 30 electrically connectable by the control body 20, and a movable mechanism 40 operable by the control body 20, as shown in FIGS. 1 and 4.

The multifunction switch 1 includes a basal plate 11 and a case 12 attached to the basal plate 11, as shown in FIG. 1.

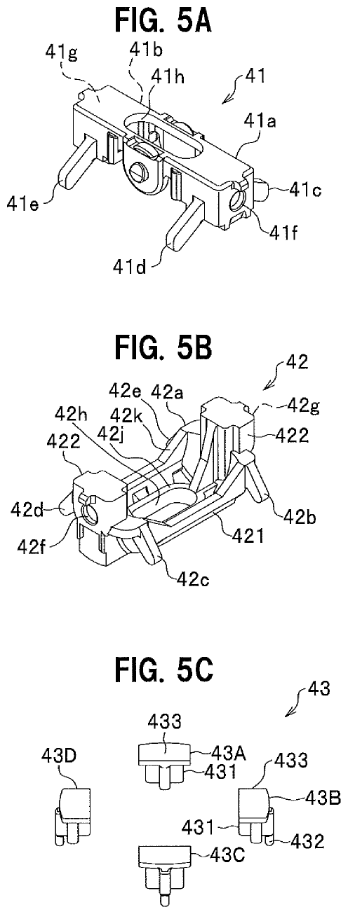

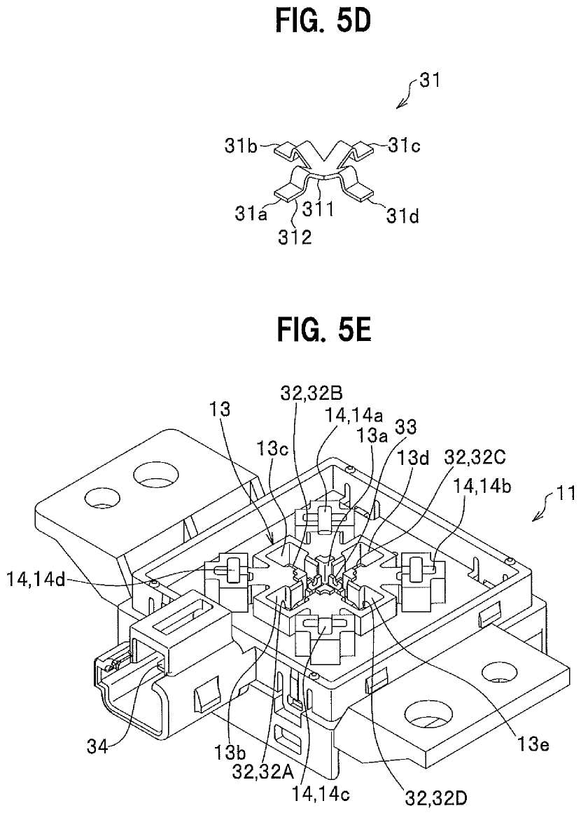

The basal plate 11 includes a contact receiver 13 protruding from a center portion thereof and a slider guide 14 disposed outside the contact receiver 13, as shown in FIG. 4. The contact receiver 13 includes a center recess 13a and outer recesses 13b, 13c, 13d, and 13e extending outward from the center recess 13a, as shown in FIG. 5E. The outer recesses 13b to 13e are arranged at intervals of an angle of 90 degrees about the center recess 13a. The slider guide 14 includes cross-shaped guide holes 14a, 14b, 14c, and 14d disposed between adjacent pairs of the outer recesses 13b to 13e.

The case 12 includes a rectangular base case 12a, a cylindrical case 12b protruding from the center of the base case 12a, and support spindles 12c, 12d, 12e, and 12f arranged on an inner peripheral surface of the cylindrical case 12b at intervals of an angle of 90 degrees about the axis of the cylindrical case, as shown in FIG. 4.

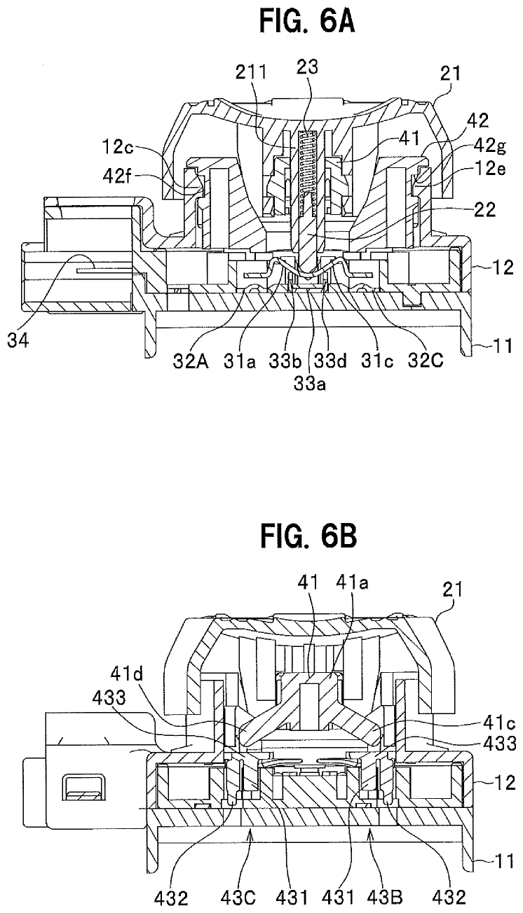

The control body 20 includes a circular control cap 21 controllable in four directions, a control pin 22 suspended from the center of the control cap 21, and a coil spring 23 attached to a base end of the control pin 22. The control cap 21 has a cylindrical portion 211 at the inner center (see FIG. 6A). The cylindrical portion 211 has the control pin 22 inserted thereinto along with a coil spring 23.

In FIG. 4, the contact circuit 30 includes a movable contact 31, a fixed contact 32 paired with the movable contact 31, a fulcrum member 33 (see FIG. 5E) made of an electric conductor for supporting the movable contact 31, and a terminal 34 electrically connected with the fixed contact 32 and the fulcrum member 33.

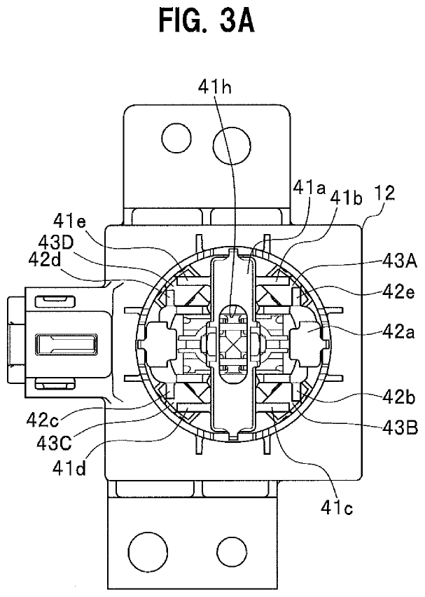

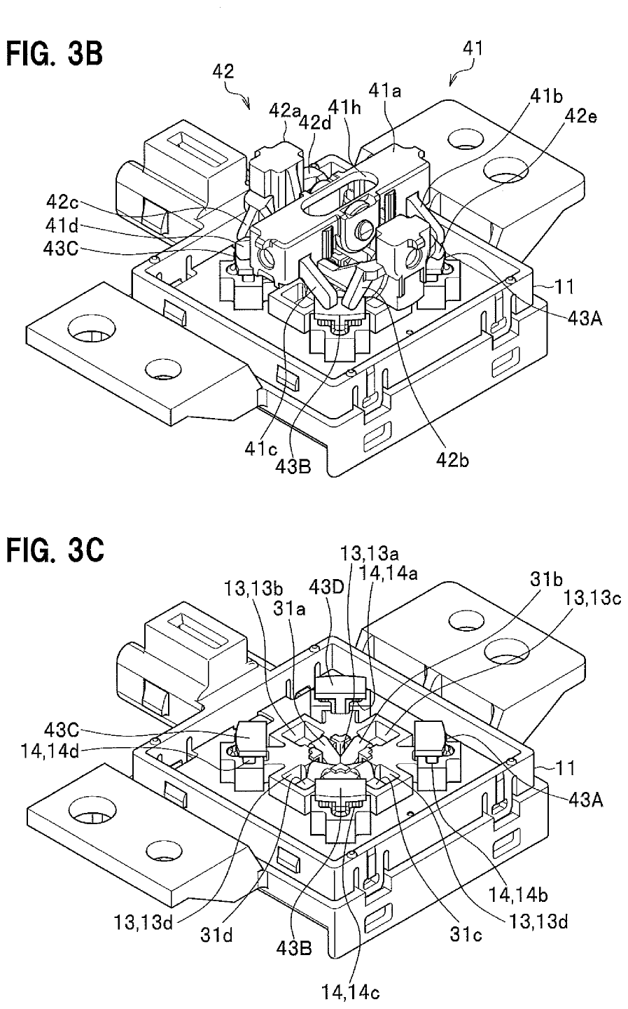

The movable contact 31 has integrally-formed movable contact plates 31a, 31b, 31c and 31d, as shown in FIG. 5D. The movable contact plates 31a to 31d extend radially from the center at intervals of an angle of 90 degrees. The movable contact plates 31a to 31d each have a swinging portion 311 extending upward, and a contact portion 312 extending downward from a top edge of the swinging portion 311 and then extending horizontally. As shown in FIG. 3C, the cross-shaped movable contact 31 is received in the contact receiver 13. The movable contact plates 31a to 31d are disposed so as to extend from the center recess 13a to the outer recesses 13b to 13e, respectively. Note that the movable contact 31 may include two movable contact plates of the movable contact plates 31a to 31d, crossing each other, depending on the number of fixed contacts, such as the movable contact plates 31a and 31b, or the movable contact plates 31a and 31d. Alternatively, the movable contact 31 may include three movable contact plates crossing each other, such as the movable contact plates 31a, 31b, 31c, or the movable contact plates 31a, 31c, 31d. Each of the movable contact plates 31a to 31d respectively corresponds to the first or second contact plate of the present invention.

The fixed contact 32 includes fixed contacts 32A, 32B, 32C, and 32D, as shown in FIG. 5E. The fixed contacts 32A to 32D are disposed in the outer recesses 13b to 13e, respectively.

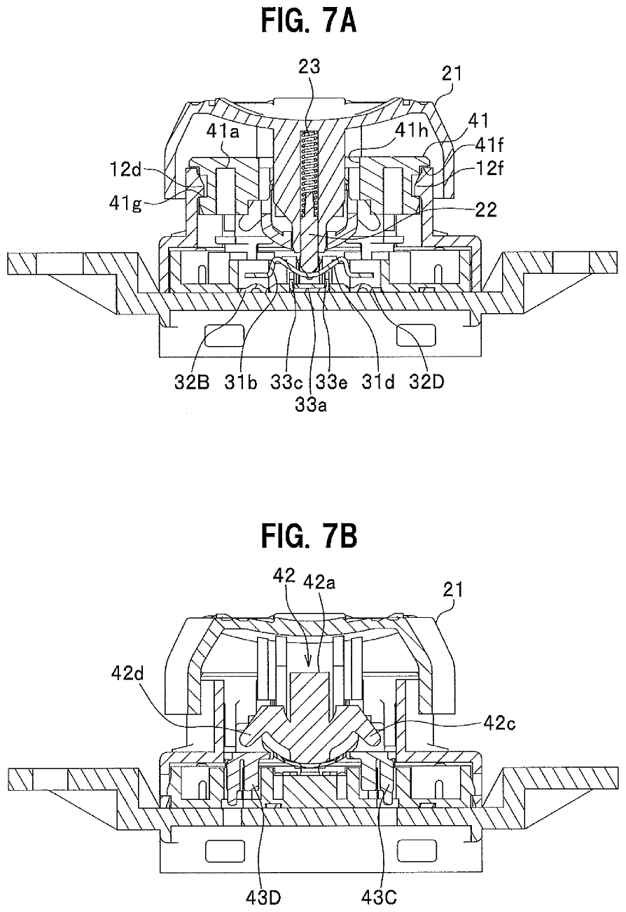

The fulcrum member 33 is disposed in the central recess 13a, as shown in FIG. 5E. The fulcrum member 33 includes a base plate 33a (see FIGS. 6A and 7A) and fulcrum plates 33b, 33c, 33d, and 33e in a concave shape extending upward from the base plate 33a toward the control body 20. The base plate 33a is disposed in the center recess 13a. The fulcrum plates 33b to 33e are respectively disposed at the boundaries between the central recess 13a and the outer recesses 13b to 13e, to support the movable contact plates 31a to 31d.

The terminal 34 includes a terminal electrically connected to the movable contact 31 via the fulcrum member 33 and a terminal connected to the fixed contact 32. The terminal 34 is electrically connected to an external electrical device, such as an electrical component of an automobile.

The movable mechanism 40 includes a first movable element 41, a second movable element 42 disposed so as to (orthogonally) cross the first movable element 41, and sliders 43A, 43B, 43C, 43D moved by the first movable element 41 and the second movable element 42, as shown in FIG. 4.

The first movable element 41 includes a body portion 41a having a hollow portion, and leg portions 41b, 41c, 41d, and 41e disposed at both ends in the longitudinal direction of the body portion 41a, as shown in FIG. 5A. The leg portions 41b and 41c extend obliquely downward from one side surface of the body portion 41a. The leg portions 41d and 41e extend obliquely downward from the opposite side surface of the body portion 42a. With reference to FIGS. 6A and 6B, the leg portions 41b and 41c are arranged on the opposite side from the movable contact plate 31a with respect to the control pin 22. The leg portions 41d and 41e are arranged on the opposite side from the movable contact plate 31c with respect to the control pin 22.

In FIG. 5A, the body portion 41a has support holes 41f and 41g in both end faces in the longitudinal direction thereof. The support spindles 12d and 12f of the case 12 are inserted into the respective support holes 41f and 41g, as shown in FIG. 7A. This makes the first movable element 41 swingably supported by the case 12.

In FIG. 5A, the body portion 41a has, in an upper surface thereof, a longitudinally-extending guide hole 41h. The guide hole 41h guides the control pin 22 to be moved in the longitudinal direction of the body portion 41a.

The second movable element 42 includes a body portion 42a in a concave shape and leg portions 42b, 42c, 42d, and 42e disposed at both ends in the longitudinal direction of the body portion 42a, as shown in FIG. 5B. The body portion 42a includes a bottom portion 421 and support portions 422 protruding from both ends in the longitudinal direction of the bottom portion 421. The leg portions 42b and 42c extend obliquely downward from one side surface of the bottom portion 421. The leg portions 42d and 42e extend obliquely downward from the opposite side surface of the bottom portion 421. With reference to FIGS. 7A and 7B, the leg portions 42b and 42c are disposed on the opposite side from the movable contact plate 31b with respect to the control pin 22. The leg portions 42d and 42e are disposed on the opposite side from the movable contact plate 31d with respect to the control pin 22.

In FIG. 5B, the body portion 42a has support holes 42f and 42g in the support portion 422 (see FIG. 6A). The support spindles 12c and 12e of the case 12 are inserted into the respective support holes 42f and 42g. This makes the second movable element 42 swingably supported by the case 12.

In FIG. 5B, the body portion 42a has a frame portion 42j that is supported by a vicinity of an opening in the bottom portion 421 and defines a longitudinally-extending guide hole 42h. The guide hole 42h is arranged so as to partially coincide with the guide hole 41h in a top view (see FIG. 3A). The guide hole 42h guides the control pin 22 to be moved in the longitudinal direction of the body portion 42a. The body portion 42a has a recess 42k defined by the bottom portion 421 and the support portion 422, and the body portion 41a of the first movable element 41 is disposed in the recess 42k (see FIG. 3B).

The sliders 43A to 43D each include a cross-shaped slide portion 431, a protrusion 432 extending from a front end of the slide portion 431, and a stopper 433 formed perpendicular to a base end of the slide portion 431, as shown in FIG. 5C. The sliders 43A to 43D are inserted into the respective guide holes 14a to 14d, as shown in FIG. 3C, and are vertically and lineally movable in the respective guide holes 14a to 14d. As shown in FIG. 3A, the slider 43A is associated with the leg portions 41b and 42e. The slider 43B is associated with the leg portions 41c and 42b. The slider 43C is associated with the leg portions 41d and 42c. The slider 43D is associated with the leg portions 41e and 42d. The sliders 43A to 43D collectively serve as a selector switch for an additional mechanical element disposed under the basal plate 11. The sliders 43A to 43D are used for mechanically switching a flow path valve or pressing respective buttons, for example. Note that biasing means to bias the sliders 43A to 43D upward may be provided in the present embodiment.

Next, operation of the multifunction switch 1 is described. As shown in FIG. 1, the multifunction switch 1 is designed such that pressing a portion 21a, 21b, 21c, or 21d of the control cap 21 downward allows for switching four contact points and switching four modes of the movable mechanism 40. In other words, the multifunction switch 1 implements 4-way switching for an electrical device and 4-way switching for an mechanical element. Hereinafter, a description is given in detail of the operation of the multifunction switch 1 in cases where the respective portions 21a to 21d are pressed.

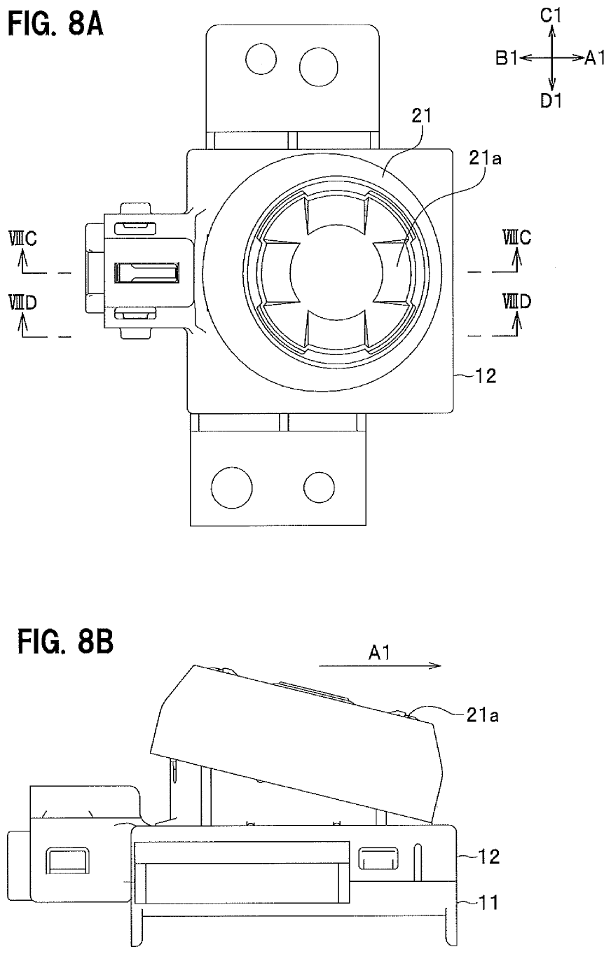

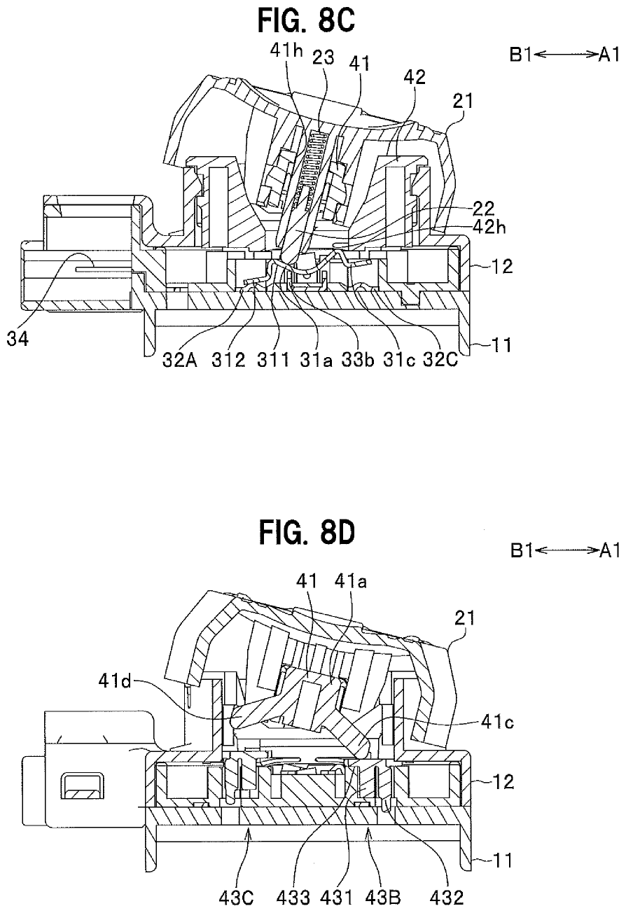

As shown in FIGS. 8A and 8B, the portion 21a of the control cap 21 is pressed downward to swing the control cap 21 toward the direction as indicated by A1. At this time, as shown in FIG. 8C, the control pin 22 is swung clockwise to make a tip of the control pin 22 slide from the lower end of the swinging portion 311 of the movable contact plate 31a toward the fulcrum plate 33b, causing the coil spring 23 to be pressed and compressed by the control pin 22. Once the control pin 22 further swings with the tip of the control pin 22 going over the fulcrum plate 33b, the control pin 22 is biased by the coil spring 23 to press the movable contact plate 31a downward. This causes the movable contact plate 31a to swing counterclockwise about the fulcrum plate 33b to make the contact portion 312 move downward and contact the fixed contact 32A. As a result, the contact circuit 30 is closed.

On another front, as shown in FIG. 8D, the control pin 22 is swung clockwise and comes in contact with the first movable element 41, to make the first movable element 41 swing clockwise. At this time, the leg portions 41b and 41c of the first movable element 41 arranged on the opposite side of the control pin 22 from the movable contact plate 31a are swung and moved downward to press the sliders 43A and 43B, respectively. The sliders 43A and 43B are moved downward. At this time, the control pin 22 is moved along the guide hole 42h of the second movable element 42, and therefore the second movable element 42 is not swung.

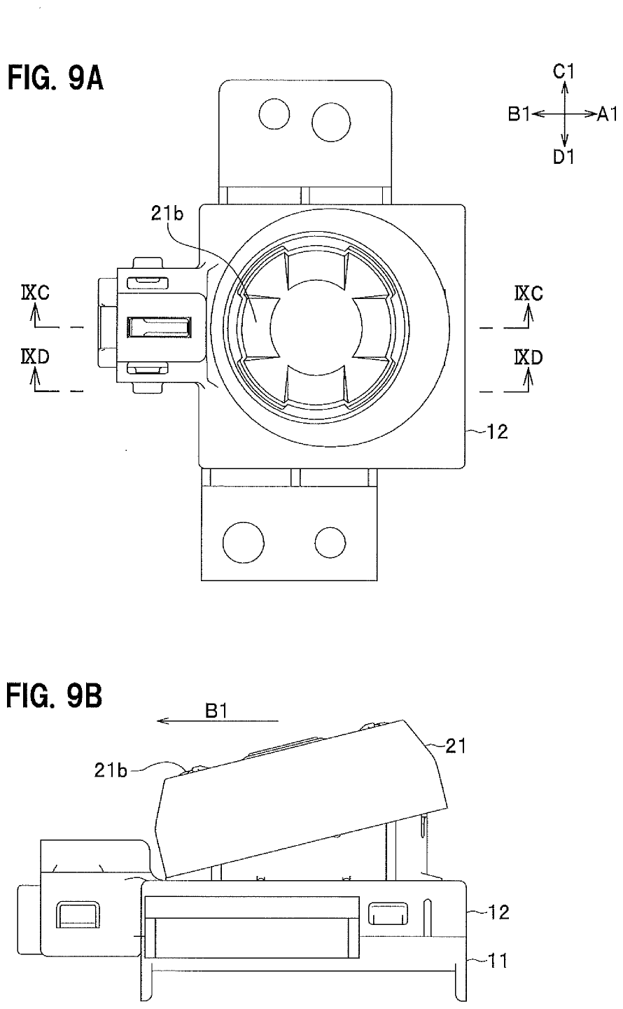

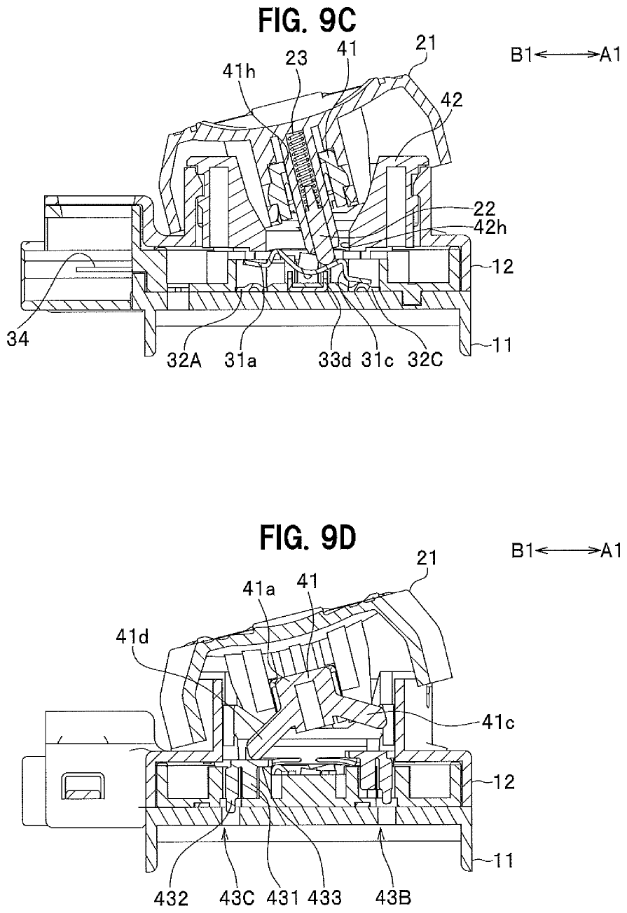

Next, as shown in FIGS. 9A and 9B, the portion 21b of the control cap 21 is pressed downward to swing the control cap 21 toward the direction as indicated by B1 opposite to A1. At this time, as shown in FIG. 9C, the control pin 22 is swung counterclockwise to make the tip of the control pin 22 slide on the movable contact plate 31c toward the fulcrum plate 33d. Once the tip of the control pin 22 goes over the fulcrum plate 33d, the control pin 22 is biased by the coil spring 23 to press the movable contact plate 31c downward. This causes the movable contact plate 31c to swing clockwise about the fulcrum plate 33d and contact the fixed contact 32C.

On another front, as shown in FIG. 9D, the control pin 22 is swung counterclockwise to make the first movable element 41 swing counterclockwise. At this time, the legs 41d and 41e of the first movable element 41 are moved downward to press the sliders 43C and 43D, respectively, and the sliders 43C and 43D are moved downward. At this time, the control pin 22 is moved along the guide hole 42h of the second movable element 42, and therefore the second movable element 42 is not swung.

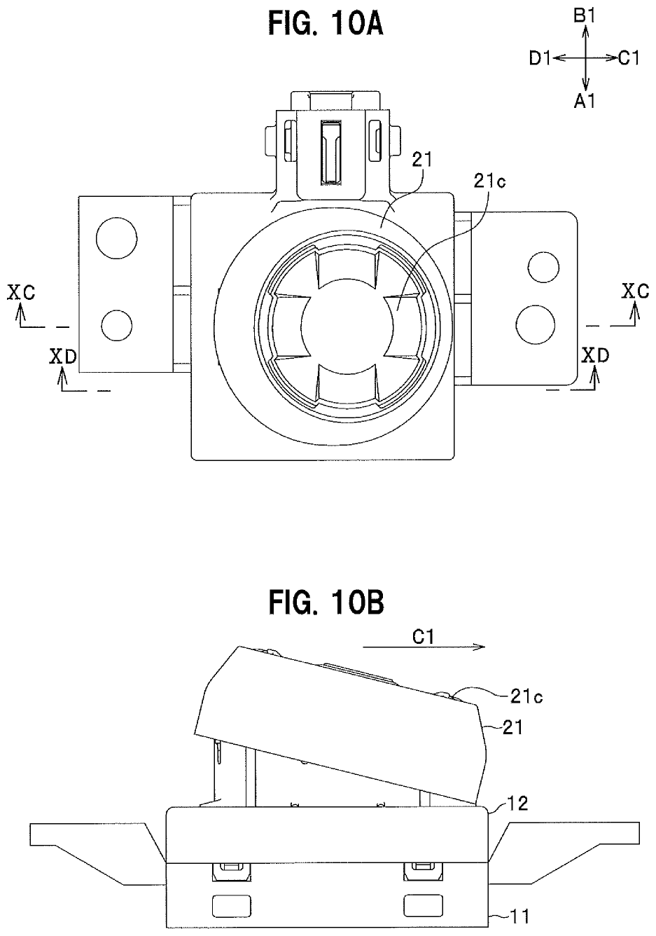

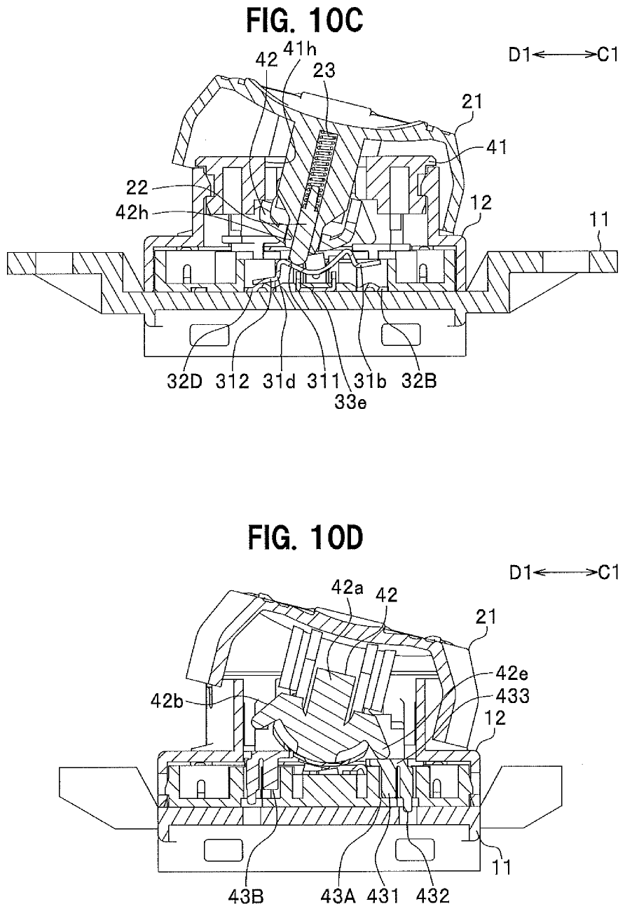

As shown in FIGS. 10A and 10B, the portion 21c of the control cap 21 is pressed downward to swing the control cap 21 toward the direction as indicated by C1 orthogonal to A1. At this time, as shown in FIG. 10C, the control pin 22 is swung clockwise to make the tip of the control pin 22 slide on the swinging portion 311 of the movable contact plate 31d toward the fulcrum plate 33e. Once the tip of the control pin 22 goes over the fulcrum plate 33e, the control pin 22 is biased by the coil spring 23 to press the movable contact plate 31d downward. This causes the movable contact plate 31d to swing counterclockwise about the fulcrum plate 33e to make the contact portion 312 of the movable contact plate 31d contact the fixed contact 32D.

On another front, as shown in FIG. 10D, the control pin 22 comes in contact with the second movable element 42 to make the second movable element 42 swing clockwise. At this time, the leg portions 42d and 42e of the second movable element 42 are moved downward to press the sliders 43D and 43A, respectively, and the sliders 43D and 43A are moved downward. At this time, the control pin 22 is moved along the guide hole 41h of the first movable element 41, and therefore the first movable element 41 is not swung.

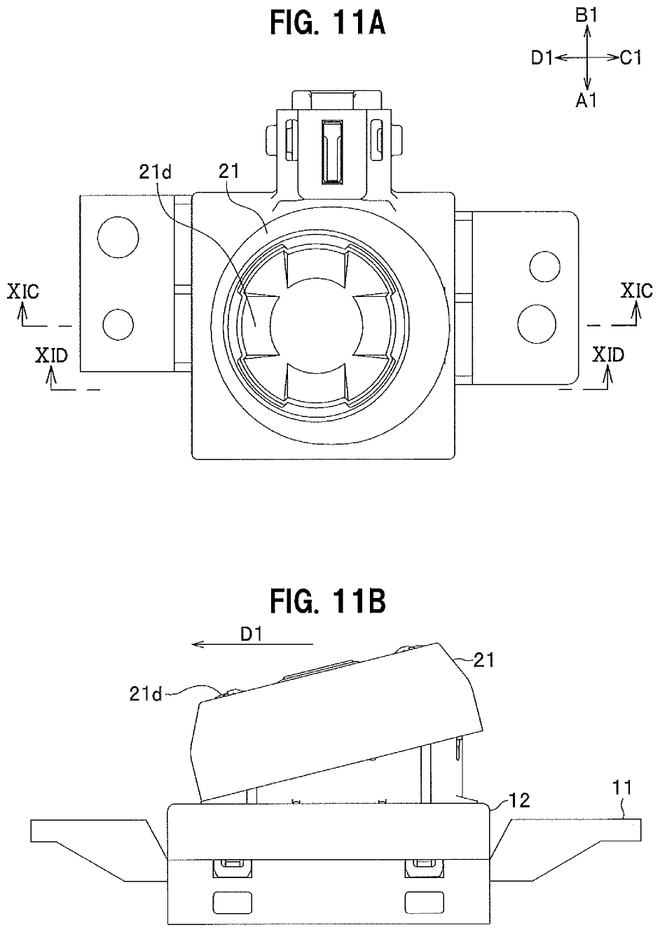

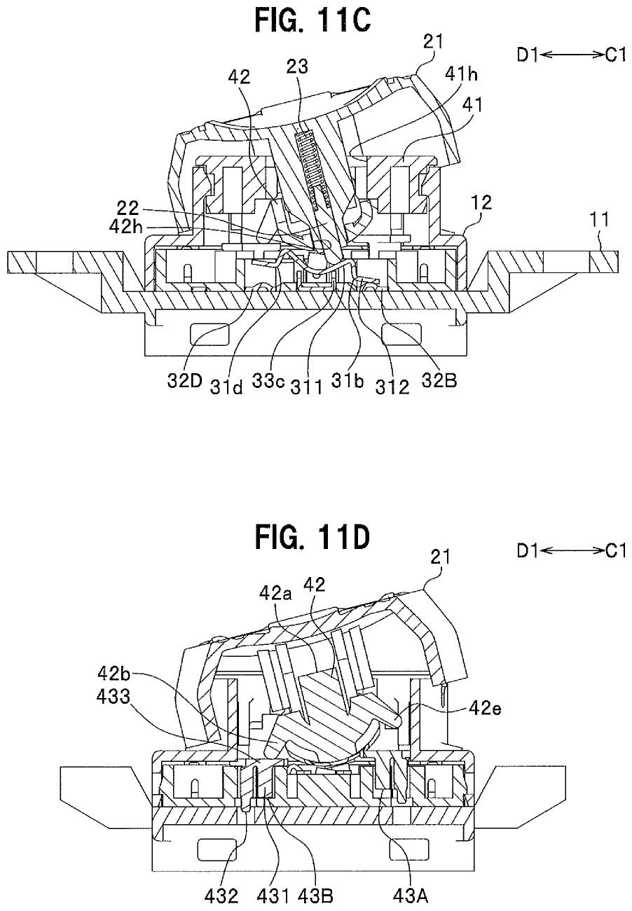

As shown in FIGS. 11A and 11B, the portion 21d of the control cap 21 is pressed downward to swing the control cap 21 toward the direction as indicated by D1 opposite to C1. At this time, as shown in FIG. 11C, the control pin 22 is swung counterclockwise to make the tip of the control pin 22 slide on the movable contact plate 31b toward the fulcrum plate 33c. Once the tip of the control pin 22 goes over the fulcrum plate 33c, the control pin 22 is biased by the coil spring 23 to press the movable contact plate 31b downward. This causes the movable contact plate 31b to swing clockwise about the fulcrum plate 33c to make the contact portion 312 of the movable contact plate 31b move downward and contact the fixed contact 32B.

On another front, as shown in FIG. 11D, the control pin 22 is swung counterclockwise to make the second movable element 42 swing counterclockwise. At this time, the leg portions 42b and 42c of the second movable element 42 are moved downward to press the sliders 43B and 43C, respectively, and the sliders 43B and 43C are moved downward. At this time, the control pin 22 is moved along the guide hole 41h of the first movable element 41, and therefore the first movable element 41 is not swung.

The above embodiment allows for implementing switching for the contact switch composed of the movable contact 31 and the fixed contact 32, and switching for a mechanical element, such as switching operation modes of a mechanical mechanism, switching for a microswitch, switching for an additional contact switch, and switching for a valve, by operating the movable mechanism 40.

The movable contact plates 31a to 31d of the movable contact 31 are integrally formed, to allow for reducing the number of parts and facilitating an assembling work. For example, if a switch is designed to include an electrical switch and an electromagnetic valve, the number of parts increases and the part costs also increase. However, the present embodiment allows for increasing variations in switching operation with the reduced number of parts and an inexpensive configuration.

The leg portions 41b to 41e and 42b to 42e can expand a movable range without expanding the body portions 41a and 42a, to allow for reducing a device in weight and operating small mechanical elements.

The sliders 43A to 43D convert rotational movements of the first movable element 41 and the second movable element 42 into linear movements, to allow for linearly moving mechanical elements.

The guide hole 41h and the guide hole 42h guide the control pin 22 being moved, to allow one of the first movable element 41 and the second movable element to be swung by the control pin 22 without being restricted by the other of the first movable element 41 and the second movable element. This allows the first movable element 41 and the second movable element 42 to be moved independently from each other.

The body portion 41a of the first movable element 41 is disposed in the recess 42k of the second movable element 42 to allow an assembled structure of the first movable element 41 and the second movable element 42 to be reduced in size.

Note that the present embodiment can be modified to have the changed number of fixed contacts so as to be a 3-contact switch, a 2-contact switch, or a 1-contact switch, not just a 4-contact switch. The movable mechanism 40 is not limited to the first movable element 41 and the second movable element 42, and may have either one of these. In addition, any number of one to four may be selected as the number of the leg portions 41b to 41e of the first movable element 41 and as the number of the leg portions 42b to 42e of the second movable element 42.

### Second Embodiment

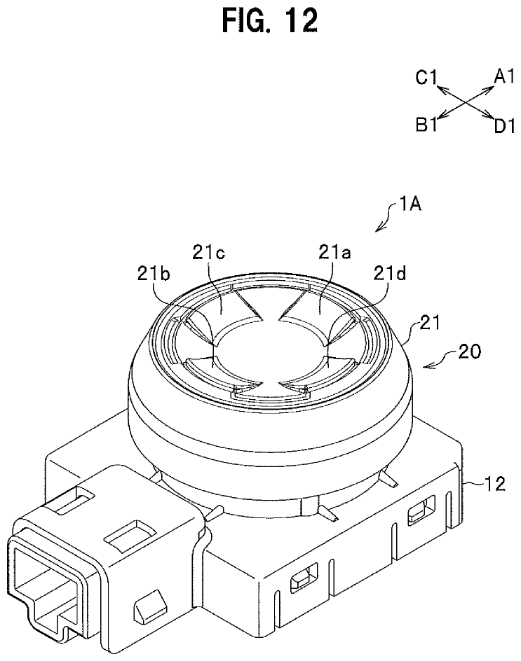

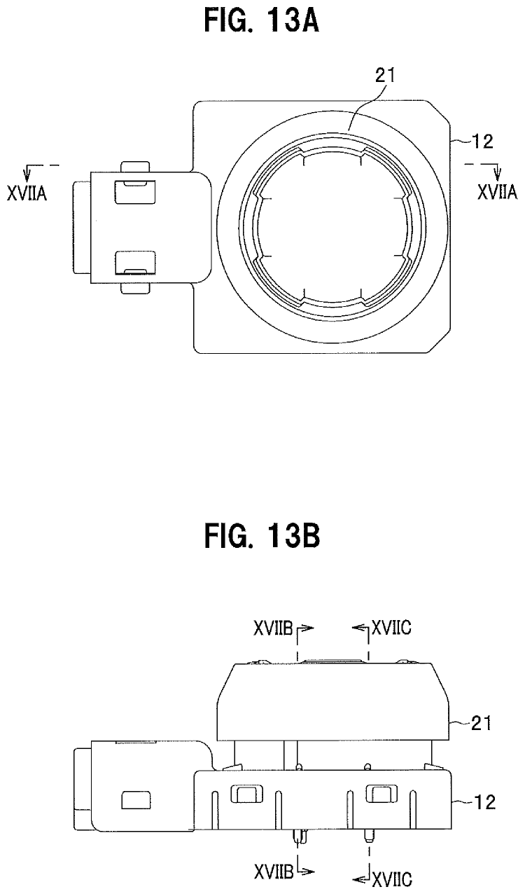

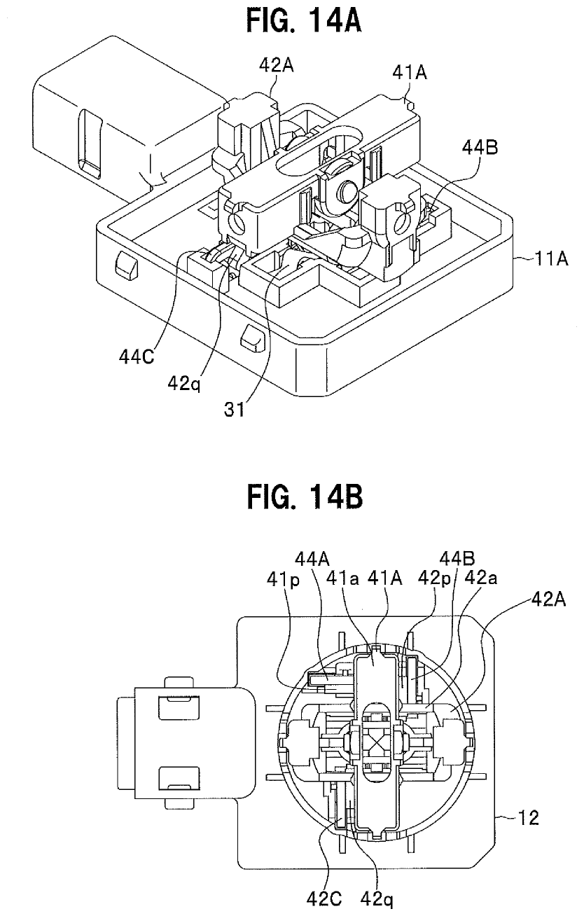

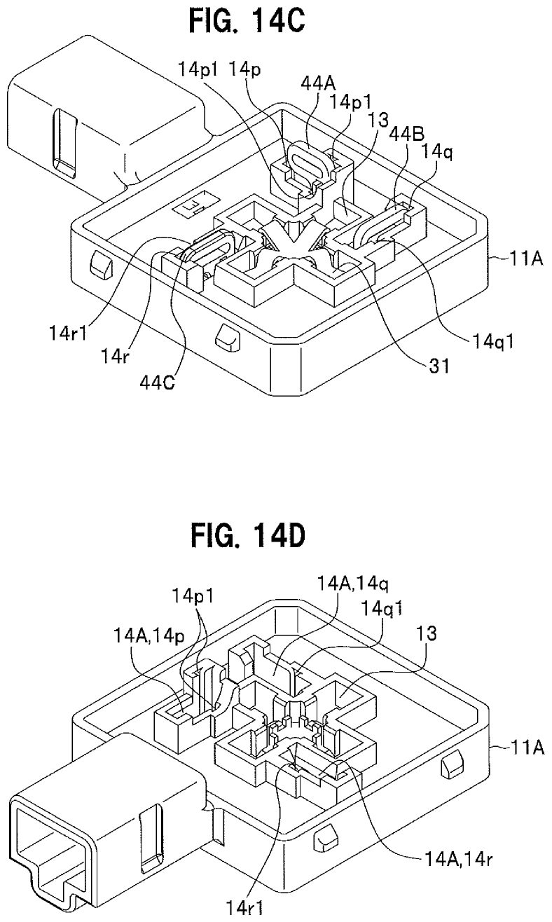

A multifunction switch 1A shown in FIG. 12 is characterised in that a first movable element 41A is coupled with a driven slider 44A and a second movable element 42A is coupled with driven sliders 44B and 44C, as shown in FIG. 14B. Hereinafter, the same members as those in the first embodiment are denoted by the same reference numerals, and descriptions thereof are eliminated.

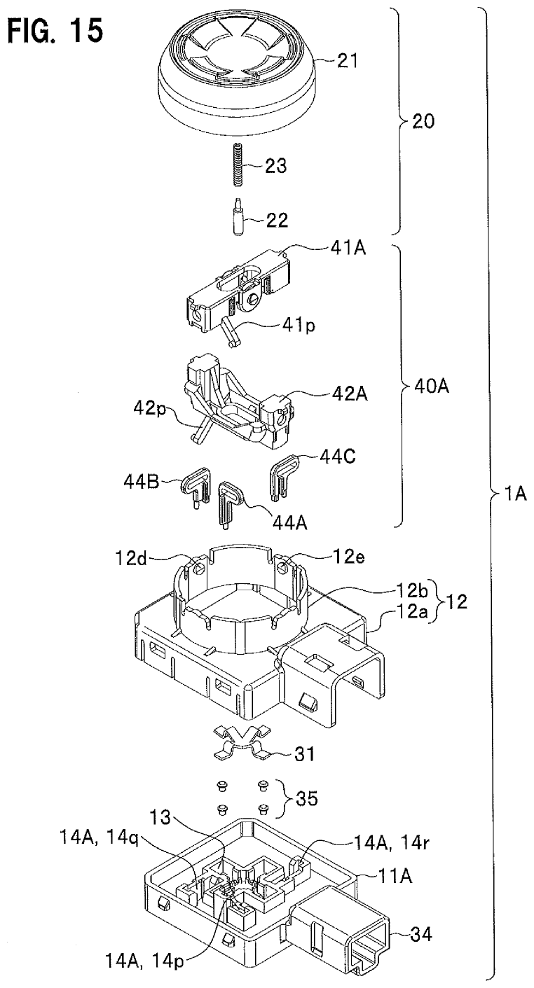

A movable mechanism 40A includes a first movable element 41A, a second movable element 42A disposed to cross the first movable element 41A, the driven slider 44A associated with the first movable element 41A, and the driven sliders 44B and 44C associated with the second movable element 42A, as shown in FIG. 15. Note that a fixed contact 35 is in a cylindrical shape.

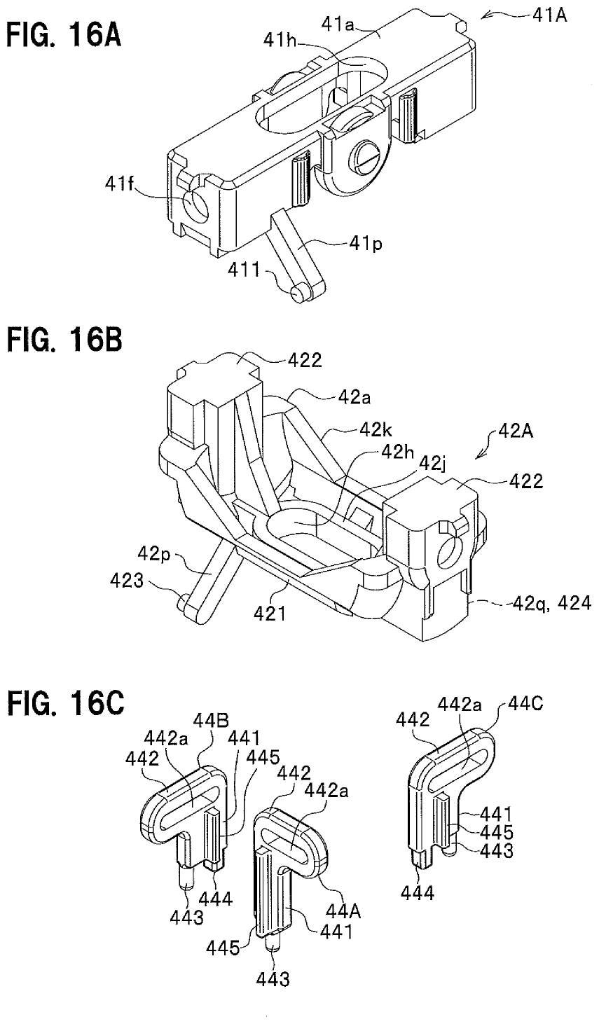

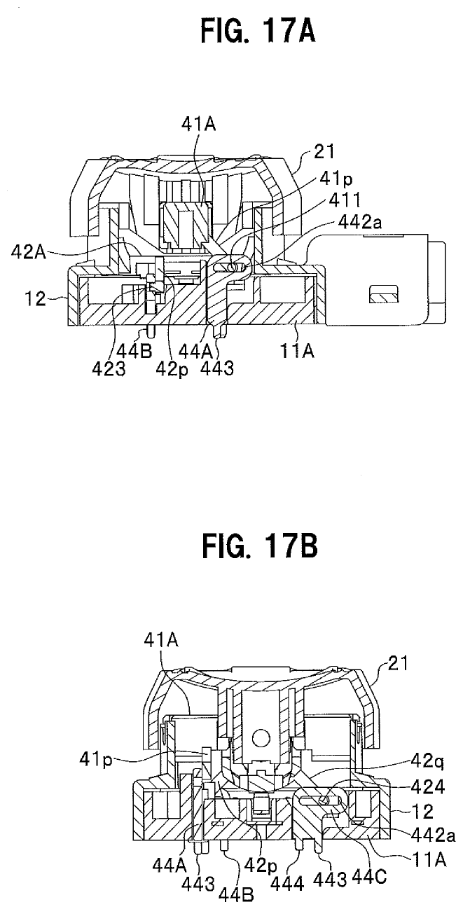

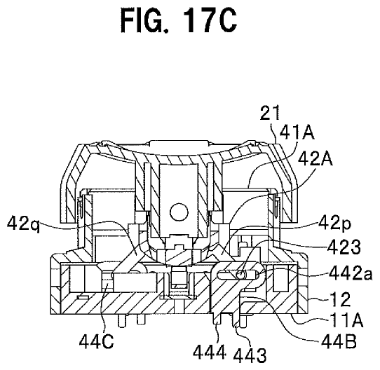

The first movable element 41A has a link leg portion 41p extending obliquely downward with respect to a side surface of a body portion 41a thereof from an edge between the side surface and a lower surface of the body portion 41a, as shown in FIG. 16A. The link leg portion 41p is set longer than the leg portions 41b to 41e of the first movable element 41 of the first embodiment. The link leg portion 41p has an engaging protrusion 411 protruding laterally from a tip thereof. The second movable element 42A has link leg portions 42p and 42q extending obliquely downward from a lower surface of a body portion 42a thereof, as shown in FIG. 16B. The link leg portion 41p has an engaging protrusion 423 protruding laterally from a tip thereof. The link leg portion 42q has an engaging protrusion 424 extending laterally from a tip thereof (see FIG. 17B). The link leg portions 42p and 42q are set longer than the leg portions 42a to 42d of the second movable element 42 of the first embodiment. As shown in FIG. 14B, the link leg portions 42p and 42q extend toward directions opposite to each other in a top view. In addition, the link leg portions 42p and 42q and the link leg portion 41p are arranged so as to form a right angle in a top view.

The driven slider 44A includes a slide portion 441, a coupling portion 442 integrated with the slide portion 441, a protrusion 443 extending from a lower end of the slide portion 441, and a positioning convex portion 445 protruding from a side surface of the slide portion 441, as shown in FIG. 16C. The coupling portion 442 has a guide hole 442a extending linearly in the lateral direction. Similarly, each driven slider 44B, 44C has a slide portion 441, a coupling portion 442, and a projection 443, and also has a projection 444 extending from the lower end of the slide portion 441.

As shown in FIG. 17A, the engaging protrusion 411 of the link leg portion 41p of the first movable element 41A is inserted into a guide hole 442a of the driven slider 44A and is slidable within the guide hole 442a. As shown in FIG. 17B, the engaging protrusion 424 of the link leg portion 42q of the second movable element 42A is inserted into the guide hole 442a of the driven slider 44C and is slidable within the guide hole 442a. As shown in FIG. 17C, the engagement protrusion 423 of the link leg portion 42p of the second movable element 42A is inserted into the guide hole 442a of the driven slider 44B and is slidable within the guide hole 442a.

As shown in FIG. 14D, a basal plate 11A has three slider guide portions 14A adjacent to the contact receiver 13. The slider guide portions 14A have guide holes 14p, 14q, and 14r, respectively. A side wall defining the guide hole 14p has a positioning recess 14p1. A side wall defining the guide hole 14q has a positioning recess 14q1. A side wall defining the guide hole 14r has a positioning recess 14r1. As shown in FIG. 14C, the driven slider 44A is received in the guide hole 14p, and the positioning convex portion 445 is disposed in the positioning concave portion 14p1. A driven slider 44B is received in the guide hole 14q, and the positioning convex portion 445 is disposed in the positioning concave portion 14q1. The driven slider 44C is received in the guide hole 14r, and the positioning convex portion 445 is disposed in the positioning concave portion 14r1.

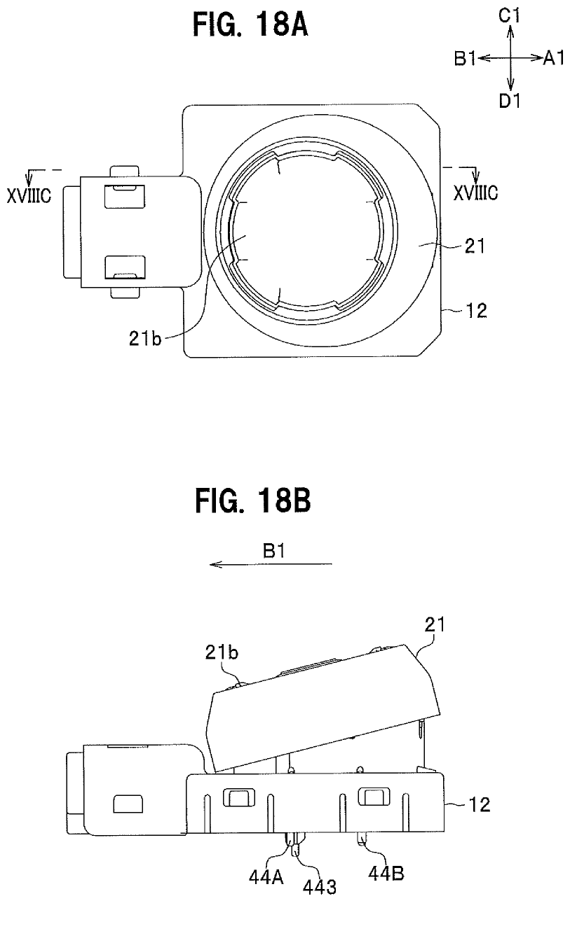

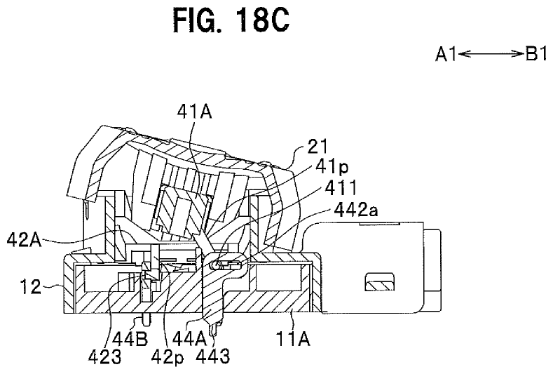

Next, operation of the multifunction switch 1A is described. Note that the operation of the contact circuit 30 is the same as that of the first embodiment, and therefore the description thereof is eliminated. As shown in FIGS. 18A and 18B, the portion 21b of the control cap 21 is pressed downward to swing the control cap 21 toward the direction as indicated by B1. At this time, the first movable element 41A is swung clockwise, as shown in FIG. 18C. The engagement protrusion 411 of the link leg portion 41p slides within the guide hole 442a toward the direction as indicated by A1 and moves the driven slider 44A downward. The protrusion 443 of the driven slider 44A presses a target element (not shown) for switching. Here, the driven slider 44A moves through a longer distance than the slider of the first embodiment, to allow the target element to have a wider movable range. In contrast, when the control cap 21 is swung toward the direction as indicated by A1 and returns to the neutral position, the first movable element 41A follows the movement of the control cap 21 and returns to the original posture, and the driven slider 44A also returns to the original position.

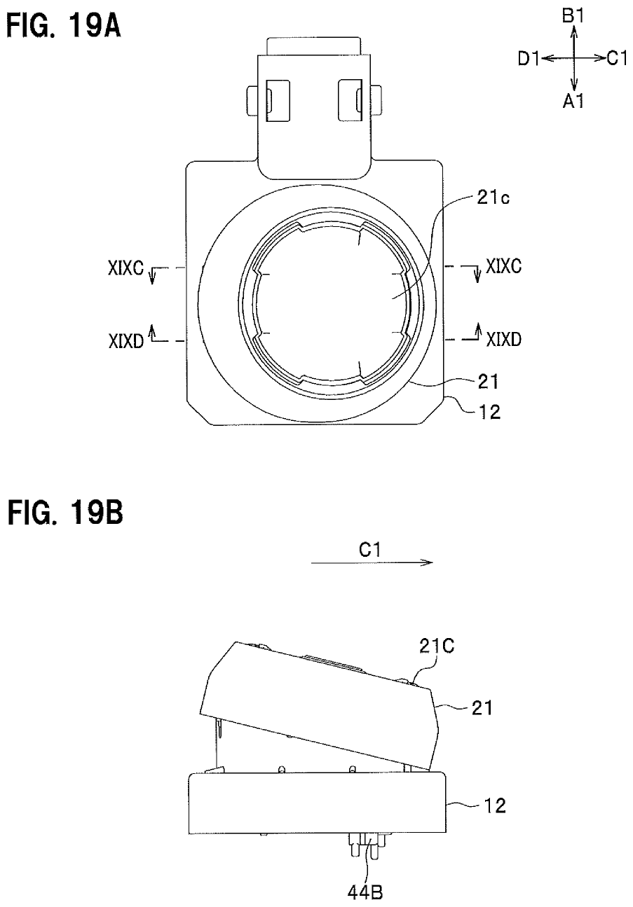

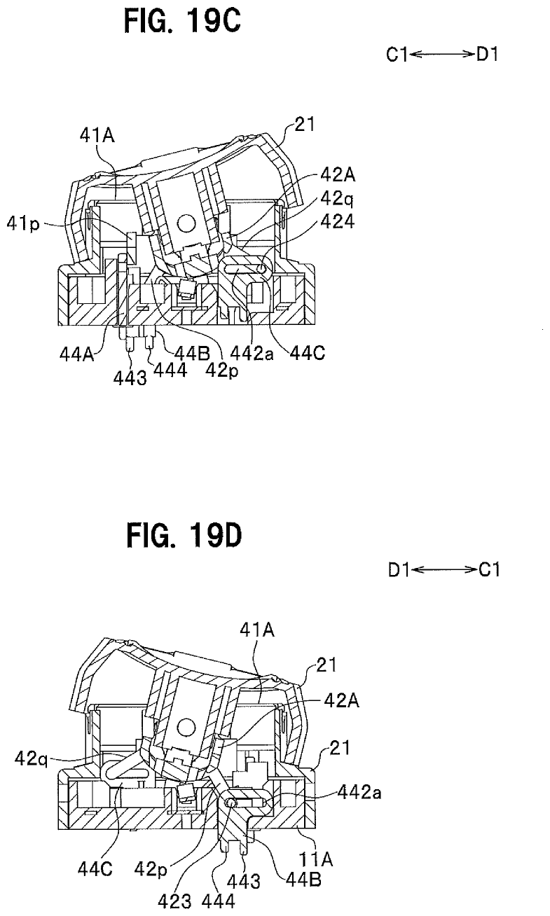

Next, as shown in FIGS. 19A and 19B, the portion 21c of the control cap 21 is pressed downward to swing the control cap 21 toward the direction as indicated by C1. At this time, the second movable element 42A is swung counterclockwise, as shown in FIG. 19C. The link leg portion 42q slides in the guide hole 442a of the driven slider 44C toward the direction as indicated by D1 and moves the driven slider 44C upward. On another front, as shown in FIG. 19D, the engaging protrusion 423 of the link leg portion 42p slides within the guide hole 442a of the driven slider 44B toward the direction as indicated by D1 and moves the driven slider 44B downward. The protrusions 443 and 444 of the driven slider 44B press a target element (not shown) for switching.

In the above multifunction switch 1A, the link leg portions 41p, 42p, and 42q are slidably coupled with the driven sliders 44A, 44B, and 44C, so that the driven sliders 44A, 44B, and 44C are allowed to have longer moving distances in accordance with the lengths of the link leg portions 41p, 42p, and 42q. This allows the target element to have a wider movable range, as compared with the first Embodiment. In addition, the link leg portions 41p, 42p, and 42q are coupled with the driven sliders 44A, 44B, and 44C, to allow the link leg portions 41 p, 42p, and 42q to surely move the driven sliders 44A, 44B, and 44C.

### Third Embodiment

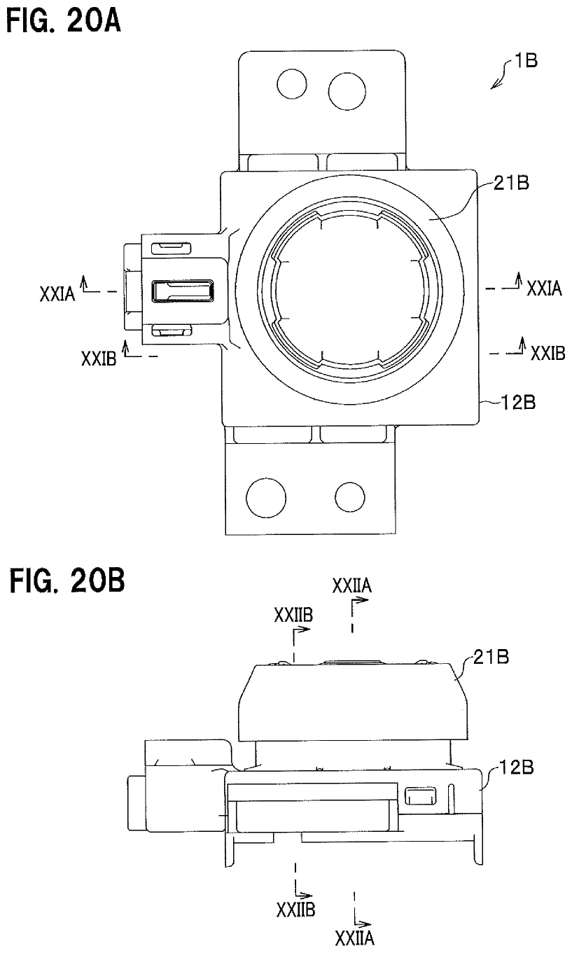

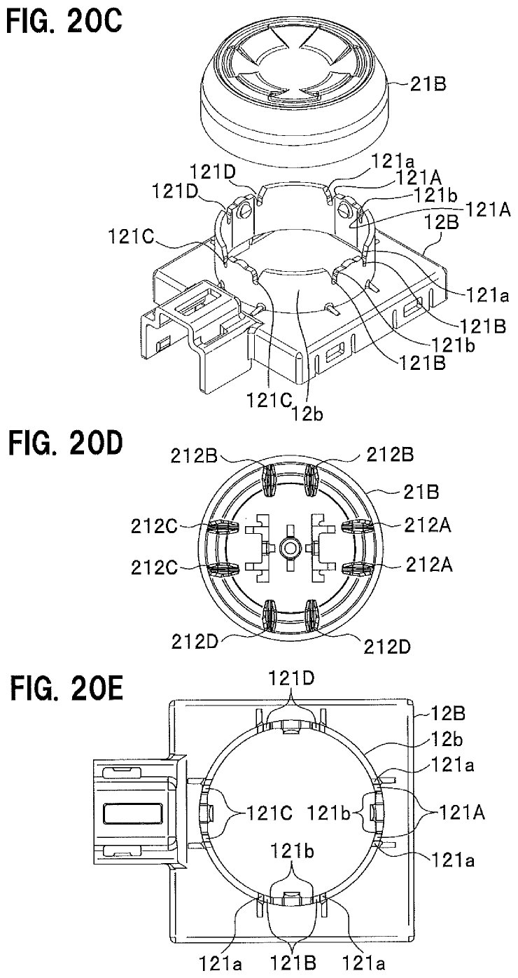

A multifunction switch 1B shown in FIGS. 20A and 20B is characterised in that a control cap 21B thereof is fixed in posture to prevent from being wrongly operated. As shown in FIG. 20D, the control cap 21B has positioning plate portions 212A, 212B, 212C, and 212D disposed, each in two locations, on the peripheral edge on the back side and formed in the circumferential direction at intervals of an angle of 90 degrees about the center thereof. As shown in FIG. 20E, a cylindrical case 12b of a case 12B of the multifunction switch 1B has slit portions 121A, 121B, 121C, and 121D formed, each in two locations, in the circumferential direction at intervals of an angle of 90 degrees about the center thereof. The slit portions 121A to 121D each extend downward from the upper end of the cylindrical case 12b. Both side walls of the respective slit portions 121A to 121D have, at upper portions thereof, guide walls 121a and 121b extending obliquely downward from the upper end of the cylindrical case 12b.

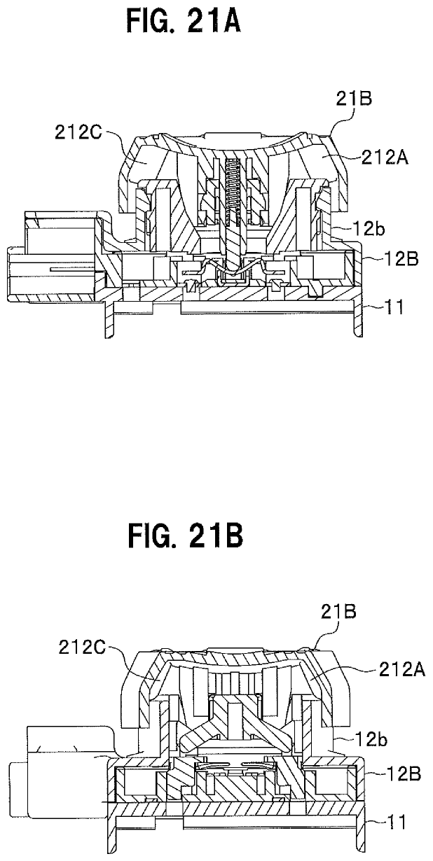

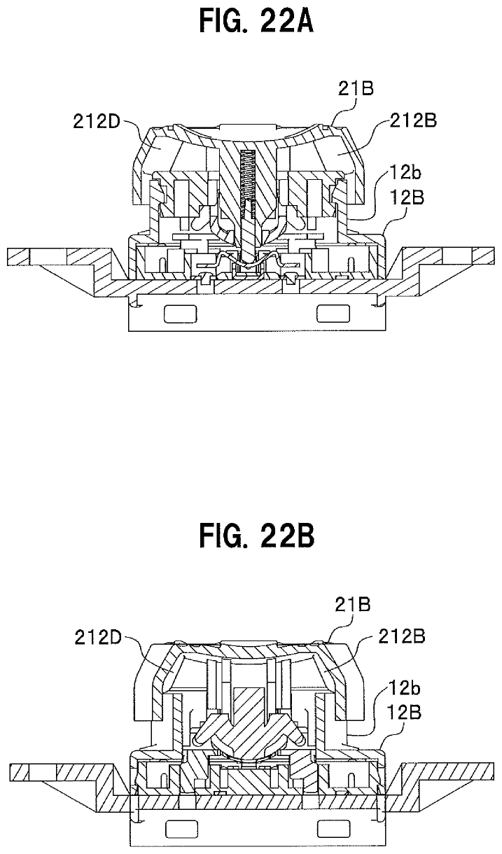

With reference to FIGS. 20D and 20E, the positioning plate portion 212A is associated with the slit portion 121A, the positioning plate portion 212B is associated with the slit portion 121B, the positioning plate portion 212C is associated with the slit portion 121C, and the positioning plate portion 212D is associated with the slit portion 121D. As shown in FIGS. 21A and 21B, the lower ends of the positioning plate portions 212A and 212B are positioned above the upper end of the cylindrical case 12b, that is, above the slit portions 121A and 121B. Similarly, as shown in FIGS. 22A and 22B, the lower ends of the positioning plate portions 212B and 212D are disposed above the upper end of the cylindrical case 12b, that is, above the slit portions 121B and 121D.

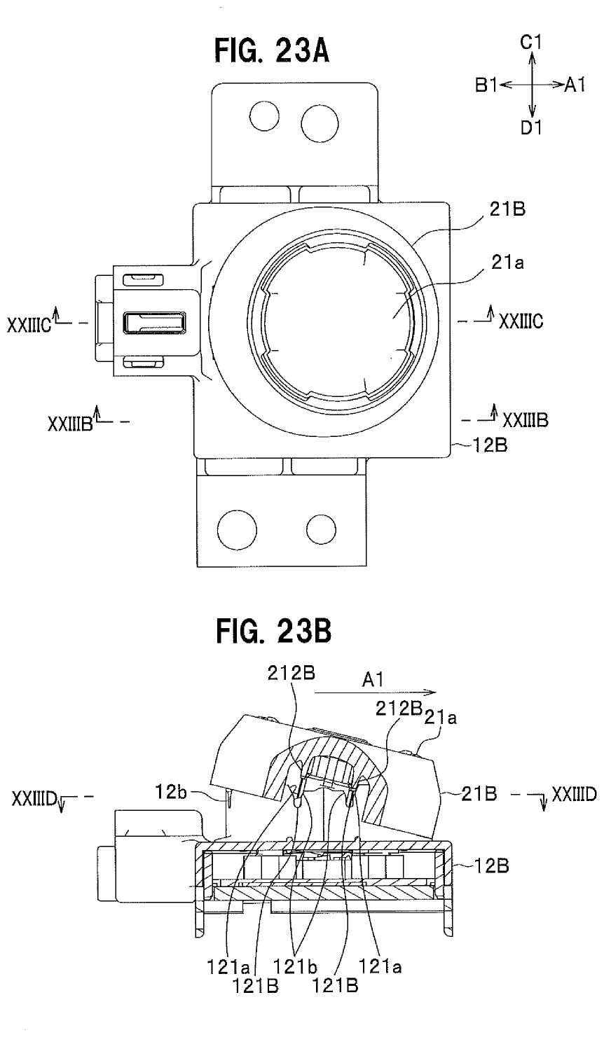

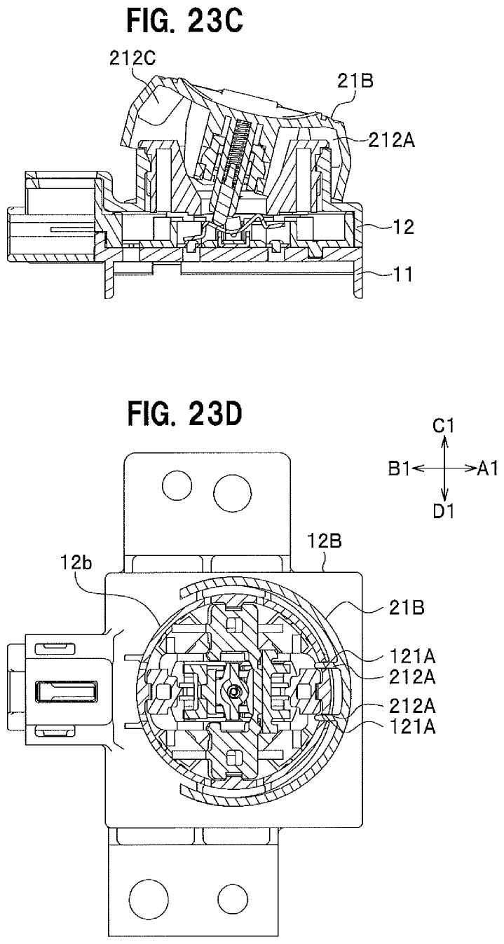

Next, operation of the multifunction switch 1B is described. As shown in FIGS. 23A and 23B, the portion 21a of the control cap 21B is pressed downward to swing the control cap 21B toward the direction as indicated by A1. At this time, the positioning plate portions 212A in FIG. 23C are moved downward. At this time, as shown in FIG. 23D, the positioning plate portions 212A are inserted into the associated slit portions 121A and positioned with respect to the cylindrical case 12b. This fixes the control cap 21B in posture so as not to be swung in other directions. In contrast, as shown in FIG. 23B, the positioning plate portions 212B are gradually tilted as the positioning plate portions 212A are moved downward, and approach the upper end of the side walls of the slit portions 121B. The upper ends of the side walls of the slit portions 121B are linearly chamfered by the guide walls 121a, and therefore the positioning plate portions 212B do not abut on the upper ends of the side walls of the slit portions 121B and do not hinder the control cap 21B from being swung.

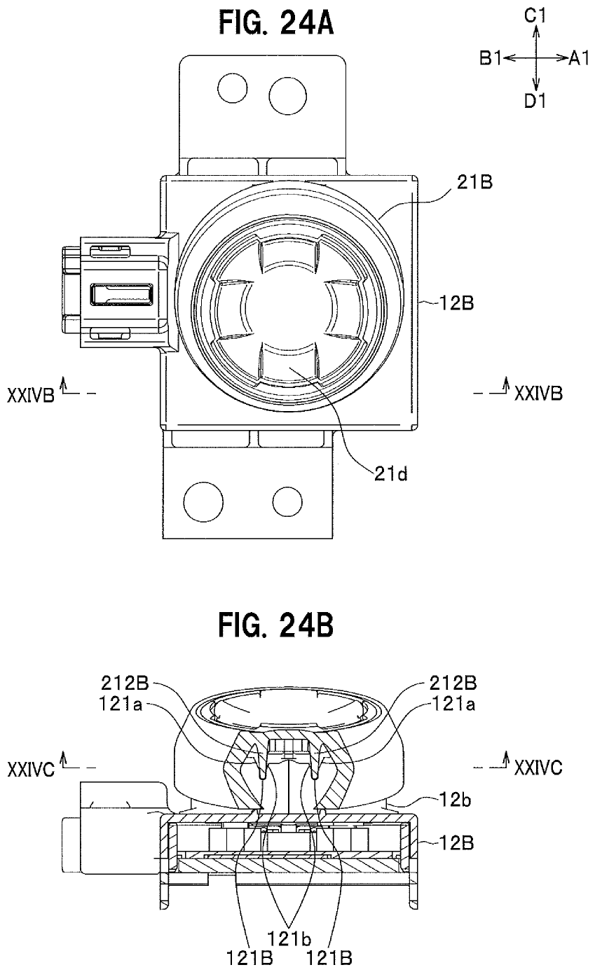

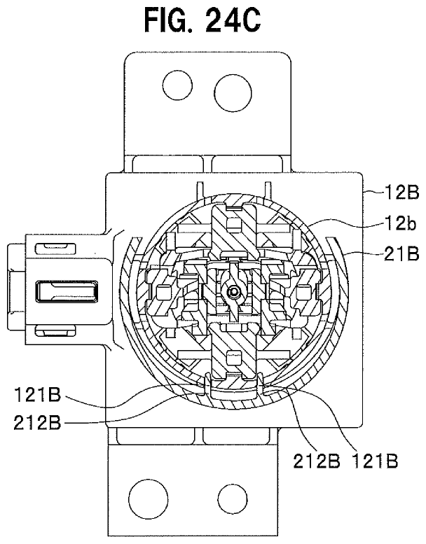

Next, as shown in FIG. 24A, the portion 21d of the control cap 21B is pressed down to swing the control cap 21B toward the direction as indicated by D1. At this time, the positioning plate portions 212B are guided by the guide walls 121a and 121b and directed to the associated slit portions 121B, as shown in FIG. 24B. Then, as shown in FIG. 24C, the positioning plate portions 212B are inserted into the associated slit portions 121B to have the control cap 21B fixed in posture so as not to be swung in other directions.

In the above multifunction switch 1B, the positioning plate portions 212A to 212D are inserted into the associated slit portions 121A to 121D, to have the control cap 21B fixed in posture so as not to be wrongly operated.

### LEGEND FOR REFERENCE NUMERALS

1 Multifunction switch; 10 Housing; 11 Basal plate; 12 Case; 13 Contact receiver; 14 Slider guide; 20 Control body; 21 Control cap; 22 Control pin; 23 Coil spring; 30 contact circuit; 31 Movable contact; 32 Fixed contacts; 33 Fulcrum member; 40 Movable mechanism; 41 First movable element; 42 Second movable element; 43A, 43B, 43C, 43D Slider; 44A, 44B, 44C, 44D Driven slider; 121A, 121B, 121C, 121D Slit portion; 212A, 212B, 212C, 212D Positioning plate portion.

We claim:

1. A multifunction switch comprising:
a swingable control body having a control pin;
a movable contact coming into contact with the control pin; and
a movable mechanism including a movable element having the control pin running therethrough and swingably supported,
wherein the movable contact is pressed by the control pin, while the control pin is swung, to come into contact with a fixed contact and the movable element is swung by the control pin to implement mechanical switching for an additional element.

2. The multifunction switch as claimed in claim 1, wherein
the movable contact includes a contact plate supported so as to be swung when the control pin slides, and
the movable element includes a leg portion arranged on the opposite side from the contact plate with respect to the control pin.

3. The multifunction switch as claimed in claim 2, wherein
the movable mechanism includes a slider to be moved when pressed by the leg portion.

4. The multifunction switch as claimed in claim 1, wherein
the control pin is swingable in a first direction and a second direction which intersect with each other, and
the movable element includes:
a first movable element swingable in the first direction by the control pin and provided with a guide hole having the control pin running therethrough and guiding the control pin in the second direction; and
a second movable element disposed so as to cross the first movable element, swingable in the second direction by the control pin, and provided with a guide hole having the control pin running therethrough and guiding the control pin in the first direction.

5. The multifunction switch as claimed in claim 4, wherein
the second movable element includes a recess in which the first movable element is disposed.

6. The multifunction switch as claimed in claim 1, wherein
the movable contact includes a first contact plate, and a second contact plate configured to cross, and integrally formed with, the first contact plate.

7. The multifunction switch as claimed in claim 3, wherein
the leg portion is slidably coupled with the slider.

8. The multifunction switch as claimed in claim 1, further comprising:
a case housing the movable element and formed with a slit portion, wherein
the control body includes a control cap to house the control pin, wherein
the control cap includes a positioning plate portion inserted into the slit portion.

9. The multifunction switch as claimed in claim 8, wherein
the slit portion extends from an upper end of the case, and
the slit portion includes a guide wall extending obliquely downward from the upper end of the case.
